(19) United States
(12) Patent Application Publication
(10) Pub. No.: US 2009/0308944 A1
(43) Pub. Date: Dec. 17, 2009

(54) Combination air deodorizer and sanitizer method

(76) Inventors: Linda S. Morrow, Pearl, MS (US); Christopher Wallace Morrow, Pearl, MS (US)

Correspondence Address: JAMES RAY & ASSOCIATES, 2640 Pitcairn Road, Monroeville, PA, 15146, US

(21) Appl. No.: 12/214,012

(22) Filed: Jun. 16, 2008

(51) Int. Cl. B05B 17/00

(52) U.S. Cl. 239/1

(57) ABSTRACT

A method of simultaneously sanitizing and deodorizing an area from a single container which includes the steps of selecting a spray dispenser and a fluid sanitizing agent. Thereafter, placing a predetermined amount, by volume, of the fluid sanitizing agent selected into the spray dispenser selected. Further, the method includes selecting a fluid deodorizing agent placing a predetermined amount, by volume, of the fluid deodorizing agent selected into such spray dispenser, thereby forming a mixture of such fluid sanitizing agent and the fluid deodorizing agent and finally dispensing the mixture of such fluid sanitizing agent and such fluid deodorizing agent formed into an area to be both sanitized and deodorized at the same time.

### CROSS REFERENCE TO RELATED APPLICATION

This patent application is related to and claims priority from U.S. Provisional Patent Application Ser. No. 60/943,579 filed Jun. 16, 2007.

### FIELD OF THE INVENTION

The present invention relates, in general, to fresh clean smelling air and, more particularly, this invention relates to a method of simultaneously delivering both an air deodorizer and sanitizer.

### BACKGROUND OF THE INVENTION

Prior to the conception and development of the present invention, as is generally well known in the prior art, there exists many occasions where it would be desirable to eliminate both unpleasant odors as well as prevent spread of germs by sanitizing the area.

Additionally, there are many types of room deodorizers that are commercially available on the market today. These prior art type deodorizers come in many different scents, sizes and ways of dispensing. Most of these deodorizers are dispensed, for example, by sprays and wicks.

Likewise, there are many types of sanitizing agents that are commercially available on the market. These prior art type sanitizing agents include Lysol and Clorox, for example. These sanitizing agents are most often used in and mixed with water and then wiped on the surface to be sanitized with a cleaning cloth. More recently, these products have been supplied in a bottle equipped with a spray.

However, applicant is not aware of any product presently available on the market which will permit the simultaneous delivery of both a deodorizing agent and a sanitizing agent.

### SUMMARY OF THE INVENTION

The present invention provides, according to a first aspect, a method of simultaneously sanitizing and deodorizing an area from a single container. The method includes the steps of selecting a spray dispenser. Thereafter, selecting a fluid sanitizing agent and placing a predetermined amount, by volume, of such fluid sanitizing agent selected into the spray dispenser selected. Further, selecting a fluid deodorizing agent and placing a predetermined amount, by volume, of such fluid deodorizing agent selected into the spray dispenser selected, thereby forming a mixture of the fluid sanitizing agent selected and the fluid deodorizing agent selected. Thereafter, dispensing such mixture of the fluid sanitizing agent selected and the fluid deodorizing agent selected into an area to be both sanitized and deodorized at the same time.

According to a second aspect, the present invention provides a method of at least one of sanitizing, deodorizing and simultaneously sanitizing and deodorizing an area from a single container. The method includes the steps of selecting a spray dispenser having at least two chambers disposed therein and a three way valve which allows dispensing two single fluids one at a time as well as a combination of such two single fluids being dispensed simultaneously. The method further includes selecting a fluid sanitizing agent and placing a predetermined amount, by volume, of the fluid sanitizing agent selected into a first one of such at least two chambers disposed within the spray dispenser selected. Additionally, the method includes selecting a fluid deodorizing agent and placing a predetermined amount, by volume, of the fluid deodorizing agent selected into a second one of such at least two chambers disposed within such spray dispenser selected. Thereafter, the method calls for determining if it is desirable to dispense only such sanitizing fluid, such deodorizing fluid or the combination of such two single fluids simultaneously. Finally, the method includes dispensing at least one of the sanitizing fluid, the deodorizing fluid and the combination of such two single fluids simultaneously.

### OBJECTS OF THE INVENTION

It is, therefore, one of the primary objects of the present invention to provide a method of each of at least one of sanitizing, deodorizing and simultaneously sanitizing and deodorizing an area from a single container.

Another object of the present invention is to provide a method of each of at least one of sanitizing, deodorizing and simultaneously sanitizing and deodorizing an area from a single container which can use a variety of scents as a deodorizing agent.

Still another object of the present invention is to provide a method of each of at least one of sanitizing, deodorizing and simultaneously sanitizing and deodorizing an area from a single container which can use a variety of sanitizing agents.

Yet another object of the present invention is to provide a method of each of at least one of sanitizing, deodorizing and simultaneously sanitizing and deodorizing an area from a single container which is simple to perform.

An additional object of the present invention is to provide a method of each of at least one of sanitizing, deodorizing and simultaneously sanitizing and deodorizing an area from a single container highly effective.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF A PRESENTLY PREFERRED AND VARIOUS ALTERNATIVE EMBODIMENTS OF THE INVENTION

According to a first aspect of the present invention there is provided a method of simultaneously sanitizing and deodorizing an area from a single dispensing container. This method includes the steps of selecting a spray dispenser. In the presently preferred embodiment of the invention, such spray dispenser selected will be from the group consisting of an aerosol spray and a pump spray. Preferably, such spray dispenser will be an aerosol spray.

The method further requires selecting a fluid sanitizing agent and, thereafter, placing a predetermined amount, by volume, of such fluid sanitizing agent selected into the spray dispenser selected. In the presently preferred embodiment of the invention, such fluid sanitizing agent is selected from the group consisting of Lysol and Clorox. Preferably, such fluid sanitizing agent selected will be Lysol.

Further, in the presently preferred embodiment of the invention, such predetermined amount, by volume, of the fluid sanitizing agent will generally be between about 25.0 to about 75.0 percent by volume. It is most preferred that such predetermined amount, by volume, of such fluid sanitizing agent will be between about 40.0 to about 60.0 percent by volume.

The method also includes the step of selecting a fluid deodorizing agent and then placing a predetermined amount, by volume, of such fluid deodorizing agent selected into such spray dispenser selected, thereby forming a mixture of the fluid sanitizing agent selected and the fluid deodorizing agent selected.

In the presently preferred embodiment of the invention, such fluid deodorizing agent will be selected from the group consisting of floral scents, spice scents, tree scents and Fabreeze. Preferably, such fluid deodorizing agent will be selected from the group consisting of floral scents and spice scents. It is most preferred that such fluid deodorizing agent is selected from the various floral scents.

Additionally, in the presently preferred embodiment of the invention, such predetermined amount, by volume, of the fluid deodorizing agent will be between about 25.0 to about 75.0 percent by volume. Preferably, such predetermined amount, by volume, of the fluid deodorizing agent is between about 40.0 to about 60.0 percent by volume.

The final essential step according to the presently preferred method is dispensing such mixture of the fluid sanitizing agent selected and the fluid deodorizing agent selected and formed into the mixture into an area to be both sanitized and deodorized at the same time.

According to a second embodiment of the present invention, there is provided a method of at least one of sanitizing, deodorizing and simultaneously sanitizing and deodorizing an area from a single container which includes selecting a spray dispenser having at least two chambers disposed therein and a three way valve which allows dispensing two single fluids one at a time and a combination of said two single fluids simultaneously.

Thereafter, selecting a fluid sanitizing agent and placing a predetermined amount, by volume, of the fluid sanitizing agent selected into a first one of such at least two chambers disposed within said spray dispenser selected. In the presently preferred embodiment of the invention, such fluid sanitizing agent is selected from the group consisting of Lysol and Clorox. Preferably, such fluid sanitizing agent selected will be Lysol. Further, such predetermined amount, by volume, of the fluid sanitizing agent will be between about 45.0 to about 55.0 percent by volume.

The method also includes selecting a fluid deodorizing agent and placing a predetermined amount, by volume, of the fluid deodorizing agent selected into a second one of such at least two chambers disposed within the spray dispenser selected.

In the presently preferred embodiment of the invention, such fluid deodorizing agent will be selected from the group consisting of floral scents, spice scents, tree scents and Fabreeze. Preferably, such fluid deodorizing agent will be selected from the group consisting of floral scents and spice scents. It is most preferred that such fluid deodorizing agent is selected from the various floral scents.

Additionally, in the presently preferred embodiment of the invention, such predetermined amount, by volume, of the fluid deodorizing agent will be between about 45.0 to about 55.0 percent by volume.

The method further requires determining if it is desirable to dispense only the sanitizing fluid, the deodorizing fluid or combination of such two single fluids simultaneously.

Thereafter, the final essential step is dispensing at least one of the sanitizing fluid, the deodorizing fluid and the combination of the two single fluids simultaneously.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A method of simultaneously sanitizing and deodorizing an area from a single container, said method comprising the steps of:
(a) selecting a spray dispenser;
(b) selecting a fluid sanitizing agent;
(c) placing a predetermined amount, by volume, of said fluid sanitizing agent, selected in step (b), into said spray dispenser, selected in step (a);
(d) selecting a fluid deodorizing agent;
(e) placing a predetermined amount, by volume, of said fluid deodorizing agent, selected in step (d), into said spray dispenser, selected in step (a), thereby forming a mixture of said fluid sanitizing agent, selected in step (b), and said fluid deodorizing agent, selected in step (d); and
(f) dispensing said mixture of said fluid sanitizing agent, selected in step (b), and said fluid deodorizing agent, selected in step (d), and formed in step (e) into an area to be both sanitized and deodorized at the same time.

2. A method, according to claim 1, wherein said spray dispenser is selected from the group consisting of an aerosol spray and a pump spray.

3. A method, according to claim 2, wherein said spray dispenser is an aerosol spray.

4. A method, according to claim 1, wherein said fluid sanitizing agent is selected from the group consisting of Lysol and Clorox.

5. A method, according to claim 4, wherein said fluid sanitizing agent is Lysol.

6. A method, according to claim 1, wherein said fluid deodorizing agent is selected from the group consisting of floral scents, spice scents, tree scents and Fabreeze.

7. A method, according to claim 6, wherein said wherein said fluid deodorizing agent is selected from the group consisting of floral scents and spice scents.

8. A method, according to claim 7, wherein said wherein said fluid deodorizing agent is selected from floral scents.

9. A method, according to claim 1, wherein said predetermined amount, by volume, of said fluid sanitizing agent is between about 25.0 to about 75.0 percent by volume.

10. A method, according to claim 9, wherein said predetermined amount, by volume, of said fluid sanitizing agent is between about 40.0 to about 60.0 percent by volume.

11. A method, according to claim 9, wherein said predetermined amount, by volume, of said fluid deodorizing agent is between about 25.0 to about 75.0 percent by volume.

12. A method, according to claim 10, wherein said predetermined amount, by volume, of said fluid deodorizing agent is between about 40.0 to about 60.0 percent by volume.

13. A method of at least one of sanitizing, deodorizing and simultaneously sanitizing and deodorizing an area from a single container, said method comprising the steps of:
(a) selecting a spray dispenser having at least two chambers disposed therein and a three way valve which allows dispensing two single fluids one at a time and a combination of said two single fluids simultaneously;
(b) selecting a fluid sanitizing agent;
(c) placing a predetermined amount, by volume, of said fluid sanitizing agent, selected in step (b), into a first one of said at least two chambers disposed within said spray dispenser, selected in step (a);
(d) selecting a fluid deodorizing agent;
(e) placing a predetermined amount, by volume, of said fluid deodorizing agent, selected in step (d), into a second one of said at least two chambers disposed within said spray dispenser, selected in step (a);
(f) determining if it is desirable to dispense only said sanitizing fluid, said deodorizing fluid and said combination of said two single fluids simultaneously; and
(g) dispensing at least one of said sanitizing fluid, said deodorizing fluid and said combination of said two single fluids simultaneously, determined in step (f).

14. A method, according to claim 13, wherein said fluid sanitizing agent is selected from the group consisting of Lysol and Clorox.

15. A method, according to claim 14, wherein said fluid sanitizing agent is Lysol.

16. A method, according to claim 13, wherein said fluid deodorizing agent is selected from the group consisting of floral scents, spice scents, tree scents and Fabreeze.

17. A method, according to claim 16, wherein said wherein said fluid deodorizing agent is selected from the group consisting of floral scents and spice scents.

18. A method, according to claim 17, wherein said wherein said fluid deodorizing agent is selected from floral scents.

19. A method, according to claim 13, wherein said predetermined amount, by volume, of said fluid sanitizing agent is between about 45.0 to about 55.0 percent by volume.

20. A method, according to claim 19, wherein said predetermined amount, by volume, of said fluid deodorizing agent is between about 45.0 to about 55.0 percent by volume.
